(19) United States
(12) Patent Application Publication
(10) Pub. No.: US 2019/0095008 A1
(43) Pub. Date: Mar. 28, 2019

(54) ELECTRONIC DEVICE

(71) Applicant: Sharp Kabushiki Kaisha, Osaka (JP)

(72) Inventors: Tetsuo MURATA, Sakai City (JP); Tomohiro KIMURA, Sakai City (JP); Yasuhiro SUGITA, Sakai City (JP); Ryuzo YUKI, Sakai City (JP)

(21) Appl. No.: 16/139,169

(22) Filed: Sep. 24, 2018

(30) Foreign Application Priority Data
Sep. 27, 2017 (JP) 2017-186850

(51) Int. Cl. G06F 3/044; G06F 3/041

(52) U.S. Cl. CPC G06F 3/044; G06F 3/0416; G06F 3/0412; G06F 2203/04104; G06F 2203/04108

(57) ABSTRACT

In order to achieve an electronic device with a high display quality while preventing a wiring pattern of a touch panel from being visually recognized in a display region, the present invention includes: a touch panel electrode (20) provided so as to surround a display region (41); and a control section (10) connected to the touch panel electrode (20) and configured to sense, in accordance with a change in capacitance of the touch panel electrode (20), a touch operation carried out by an object coming into contact with or coming closer to at least one of the display region (41) and a frame region (50).

This Nonprovisional application claims priority under 35 U.S.C. §119 on Patent Application No. 2017-186850 filed in Japan on Sep. 27, 2017, the entire contents of which are hereby incorporated by reference.

### TECHNICAL FIELD

The present invention relates to an electronic device, particularly to an electronic device including a touch panel.

### BACKGROUND ART

Conventionally known is a touch-operable electronic device including a touch panel. For example, Patent Literature 1 discloses a so-called wearable device which is of a watch type and includes a capacitive touch panel.

### CITATION LIST

### Patent Literature

[Patent Literature 1]

U.S. Patent Application Publication No. 2014/0139637 (Publication Date: May 22, 2014)

### SUMMARY OF INVENTION

### Technical Problem

Note, however, that according to such a conventional technique as described earlier, a capacitive touch panel is provided on a display screen. This unfortunately causes a wiring pattern of the touch panel to be visually recognized in a display region, and consequently impairs a display quality of the display screen.

An aspect of the present invention has an object to achieve an electronic device with a high display quality while preventing a wiring pattern of a touch panel from being visually recognized in a display region.

### Solution to Problem

In order to attain the object, an electronic device in accordance with an aspect of the present invention is an electronic device including: a display device including a display region and a frame region; a touch panel electrode provided so as to surround the display region; and a control section connected to the touch panel electrode and configured to sense, in accordance with a change in capacitance of the touch panel electrode, a touch operation carried out by an object coming into contact with or coming closer to at least one of the display region and the frame region.

### Advantageous Effects of Invention

An aspect of the present invention brings about an effect of achieving an electronic device with a high display quality while preventing a wiring pattern of a touch panel from being visually recognized in a display region.

### BRIEF DESCRIPTION OF DRAWINGS

FIG. 1 is a block diagram schematically illustrating a configuration of an electronic device in accordance with Embodiment 1.

FIG. 2 is a cross-sectional view illustrating the configuration of the electronic device in accordance with

Embodiment 1.

FIG. 3 is a cross-sectional view illustrating the configuration of the electronic device in accordance with Embodiment 1.

(a) through (d) of FIG. 4 are views each schematically illustrating an external appearance of the electronic device in accordance with Embodiment 1.

(a) and (b) of FIG. 5 are views each illustrating a configuration of an electronic device of a variation of Embodiment 1.

FIG. 6 is a view showing an example of a touch operation carried out with respect to the electronic device of Embodiment 1.

FIG. 7 is a block diagram schematically illustrating a configuration of an electronic device of Embodiment 2.

FIG. 8 is a view schematically illustrating the configuration of the electronic device of Embodiment 2.

FIG. 9 is a view showing an example of a touch operation carried out with respect to the electronic device of Embodiment 2.

FIG. 10 is a view schematically illustrating a configuration of an electronic device of Embodiment 3.

(a) through (d) of FIG. 11 are views each showing an example of a touch operation carried out with respect to the electronic device of Embodiment 3.

(a) and (b) of FIG. 12 are views each showing an example of the touch operation carried out with respect to the electronic device of Embodiment 3.

(a) of FIG. 13 is a view schematically illustrating a configuration of an electronic device of Embodiment 4. (b) and (c) of FIG. 13 are views each showing an example of a touch operation carried out with respect to the electronic device of Embodiment 4.

(a) through (c) of FIG. 14 are views each illustrating a principle on which to calculate a touch position in the electronic device of Embodiment 4.

(a) and (b) of FIG. 15 are views each illustrating a principle on which to calculate the number of fingers with use of which to carry out the touch operation with respect to the electronic device of Embodiment 4.

(a) through (d) of FIG. 16 are views each illustrating a principle on which to calculate touch positions at which the touch operation is carried out, with use of a respective plurality of fingers, with respect to the electronic device of Embodiment 4.

### DESCRIPTION OF EMBODIMENTS

### Embodiment 1

The following description specifically discusses an electronic device 101 in accordance with an embodiment of the present invention.

[Configuration of Electronic Device 101]

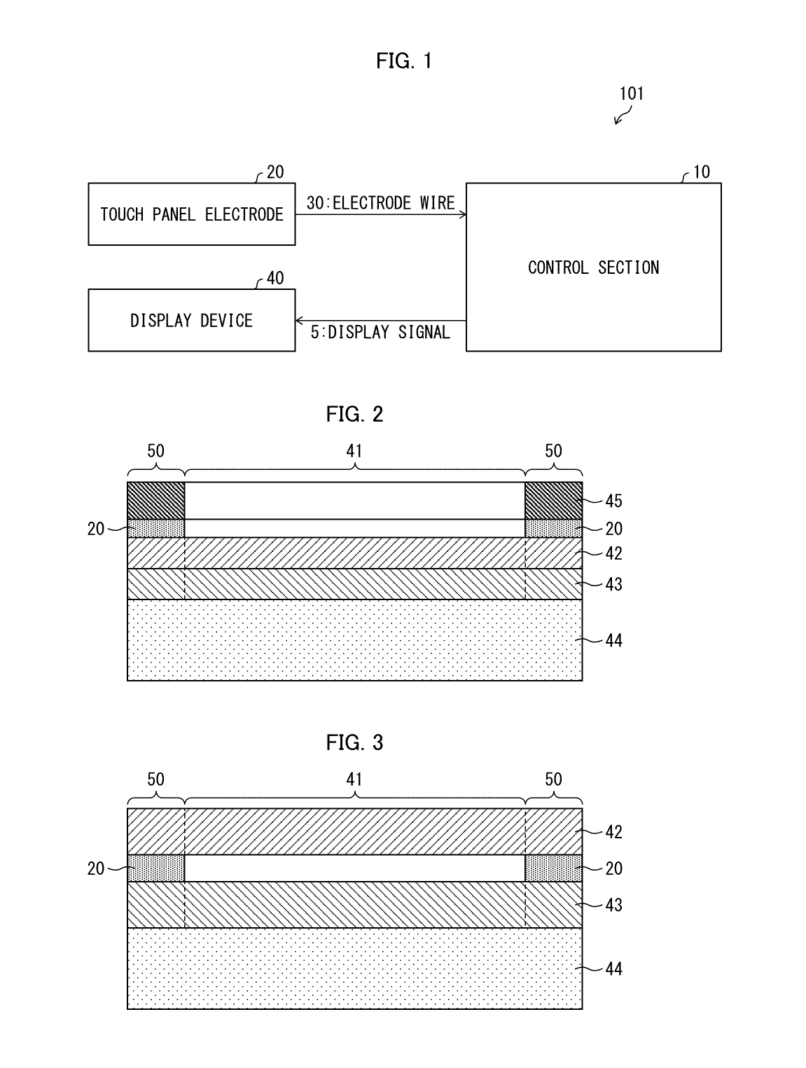

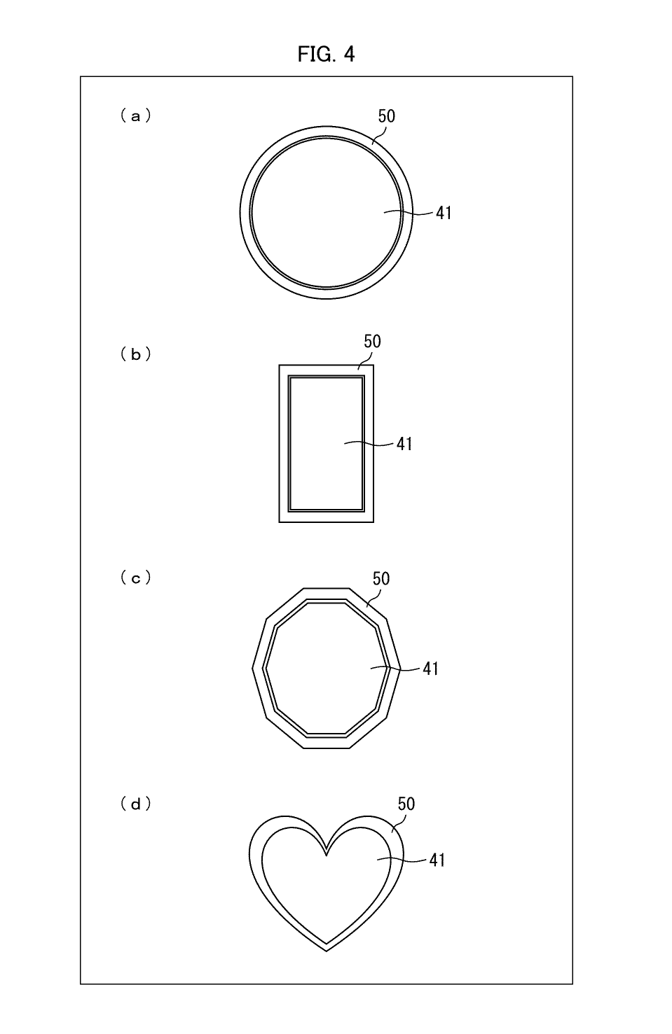

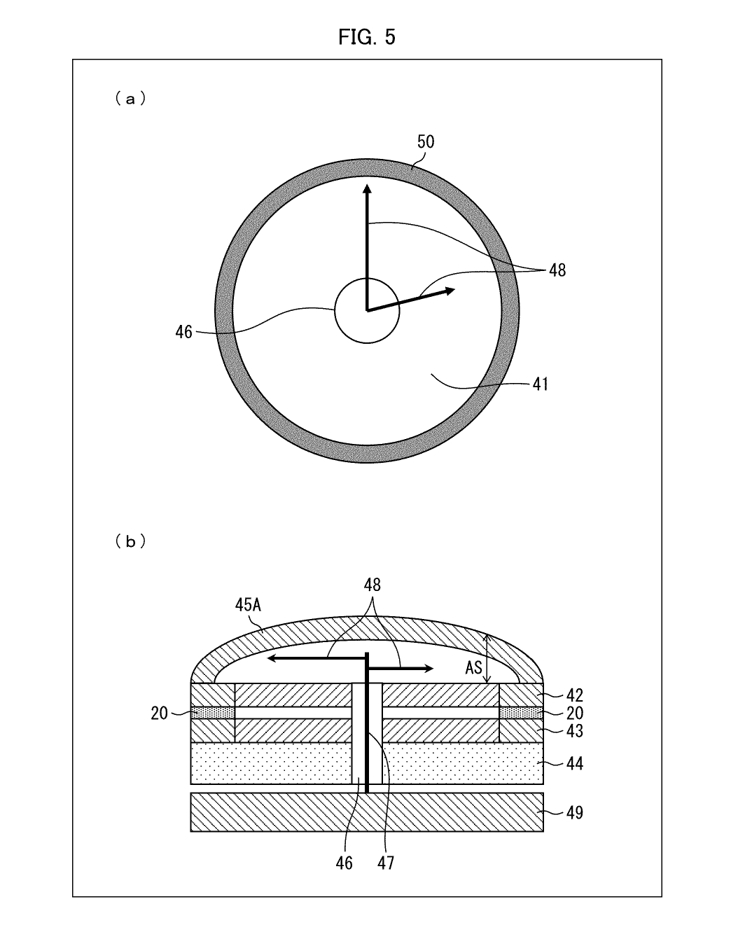

FIG. 1 is a block diagram schematically illustrating a configuration of the electronic device 101. FIGS. 2 and 3 are cross-sectional views each illustrating the configuration of the electronic device 101. (a) through (d) of FIG. 4 are plan views each illustrating an external appearance of the electronic device 101.

As illustrated in FIG. 1, the electronic device 101 includes a touch panel electrode 20, a display device 40, and a control section 10.

The touch panel electrode 20 is used as a sensor configured to sense, by a capacitive method, a touch operation carried out by a user. In a case where an object comes closer to the touch panel electrode 20, the touch panel electrode 20 changes in capacitance due to a weak electric current which flows between the touch panel electrode 20 and the object. The touch panel electrode 20 is connected to the control section 10 by an electrode wire 30. The touch panel electrode 20 supplies, to the control section 10 via the electrode wire 30, the change in capacitance in a form of a signal.

The display device 40 is a display device which is controlled by the control section 10. The display device 40 can be, for example, a liquid crystal display device or an organic Electro Luminescence (EL) display device.

The control section 10 is an arithmetic unit which has a function of controlling sections of the electronic device 101 as a whole. The control section 10 controls each component of the electronic device 101 by, for example, execution, by one or more processors (e.g., a CPU), of a program stored in one or more memories (e.g., a RAM and a ROM).

Furthermore, the control section 10 senses a change in capacitance of the touch panel electrode 20 by monitoring a signal which is obtained from the touch panel electrode 20 via the electrode wire 30 and indicates the change in capacitance, so that the control section 10 senses the object coming closer to the touch panel electrode 20. Moreover, the control section 10 can also control the sections of the electronic device 101 in accordance with the change in capacitance of the touch panel electrode 20.

For example, the control section 10 calculates, in accordance with the change in capacitance of the touch panel electrode 20, (i) details and the number of times of the touch operation carried out by the user with respect to the touch panel electrode 20 or (ii) a touch position, at which the touch operation is carried out, so as to specify a function which should be carried out in accordance with the touch operation carried out by the user. The control section 10 which has specified the function controls the sections of the electronic device 101 so that the specified function is carried out. Furthermore, the control section 10 can also control a display of the display device 40 by generating a display signal 5 for controlling a graphical interface which is displayed in the display device 40 in accordance with the touch operation carried out by the user with respect to the touch panel electrode 20.

Note that, in a case where the electronic device 101 is, for example, a so-called wearable device of a watch type and is a small-sized subdevice which functions in cooperation with other main devices such as a smartphone and a tablet device, the electronic device 101 can be configured such that the control section 10 is provided on the main device side. The electronic device 101 can be configured to (i) communicate, via wireless communications such as Wi-Fi (Registered Trademark) and Bluetooth (Registered Trademark), with the control section 10 which is provided on the main device side, (ii) transmit, to the control section 10 via the wireless communications, the change in capacitance of the touch panel electrode 20 in the form of a signal, and (iii) receive, from the control section 10, control signals including the display signal 5.

(Location of Formation of Touch Panel Electrode)

As illustrated in FIGS. 2 and 3, the display device 40 is a flat panel display which includes a CF substrate 42, a TFT substrate 43, and a back bezel 44 serving as a light source.

The touch panel electrode 20 is provided so as to surround a display region 41 of the display device 40. The display device 40 includes the display region 41 and a frame region 50 which surrounds the display region 41 so as to frame the display region 41. The touch panel electrode 20 is provided in the frame region 50.

As illustrated in FIG. 2, the display device 40 can be configured to have a surface which is covered by a cover glass 45. The touch panel electrode 20 can be configured to be provided between the cover glass 45 and the CF substrate 42. The touch panel electrode 20 can alternatively be configured to be provided on a TP substrate which is provided on the CF substrate 42. The touch panel electrode 20 can alternatively be configured to be provided on the CF substrate 42. The electronic device 101 thus can be in a form of an out-cell touch panel in which the touch panel electrode 20 is provided so as to be located between the CF substrate 42 and the cover glass 45 which covers a surface of the CF substrate.

Alternatively, as illustrated in FIG. 3, the touch panel electrode 20 can be configured to be provided on the TP substrate which is provided between the CF substrate 42 and the TFT substrate 43. The electronic device 101 thus can be in a form of an in-cell touch panel in which the touch panel electrode 20 is provided so as to be located between the CF substrate 42 and the TFT substrate 43.

The touch panel electrode 20 which is configured as described above is provided in the frame region 50 which surrounds the display region 41. This prevents a wiring pattern of a touch panel from being visible in the display region 41, and consequently prevents impairment of a display quality of the display device 40. Furthermore, the wiring pattern of the touch panel, which wiring pattern is invisible in the display region 41, causes no reduction in transmittance of the display region 41. This allows the display region 41 to be brighter, or allows a reduction in electric power of the back bezel 44. Moreover, since the touch operation can be carried out by touching the frame region 50 which surrounds the display region 41, the display region 41 is touched with a finger fewer times so that the touch operation is carried out. This allows fewer opportunities for the display region 41 to be made dirty with, for example, a fingerprint.

(External Appearance of Electronic Device 101)

The electronic device 101 has an external appearance which is not limited in shape. For example, the electronic device 101 can have an external appearance such that the electronic device 101 includes the display region 41 which is circular (see (a) of FIG. 4). The electronic device 101 can alternatively have an external appearance such that the electronic device 101 includes the display region 41 which is rectangular (see (b) of FIG. 4). The electronic device 101 can alternatively have an external appearance such that the electronic device 101 includes the display region 41 which is polygonal (see (c) of FIG. 4). The electronic device 101 can alternatively have an external appearance such that the electronic device 101 includes the display region 41 which is heart-shaped (see (d) of FIG. 4).

(a) through (d) of FIG. 4 each illustrate the configuration of the electronic device 101 such that the display region 41 and the frame region 50 are identical in shape. Note, however, that the display region 41 and the frame region 50 do not necessarily need to be identical in shape. The electronic device 101 only needs to be configured such that the display region 41 is entirely surrounded by the frame region 50. For example, the electronic device 101 can be configured such that the display region 41 which is circular is surrounded by the frame region 50 which is rectangular.

(Variation of Electronic Device 101)

FIG. 5 is a view illustrating an electronic device 101 of a variation. (a) of FIG. 5 is a view illustrating an external appearance of the electronic device 101 of the variation which electronic device 101 is viewed from the front. (b) of FIG. 5 is a cross-sectional view of the electronic device 101 of the variation. As illustrated in (a) and (b) of FIG. 5, the electronic device 101 of the variation includes a protruding cover glass 45A having a swollen surface, and has, between a display device 40 and the cover glass 45A, an air gap AS which has a given height. The display device 40 of the electronic device 101 is provided with a needle hole 46 which is through a CF substrate 42, a TFT substrate 43, and a back bezel 44. The electronic device 101 includes a movement 49 which is provided below the back bezel 44 and a needle shaft 47 which extends above the display device 40 from the movement 49 through the needle hole 46. The needle shaft 47 is provided with a needle 48 which includes a short needle and a long needle and which can rotate on the needle shaft 47.

As described earlier, the electronic device 101 includes (i) a touch panel electrode which is provided in a frame region 50 which surrounds a display region 41 and (ii) a control section 10 which senses an object coming closer to the touch panel electrode. According to the electronic device 101 which is configured as described above, a user interface which is operated by a touch operation can be achieved also in a timepiece in which the needle hole 46 is provided in the display region 41 and in the electronic device 101 which has the air gap AS between the display device 40 and the cover glass 45A. Thus, it is possible to design an external appearance of the electronic device 101 with higher degree of freedom.

(Example of Touch Operation)

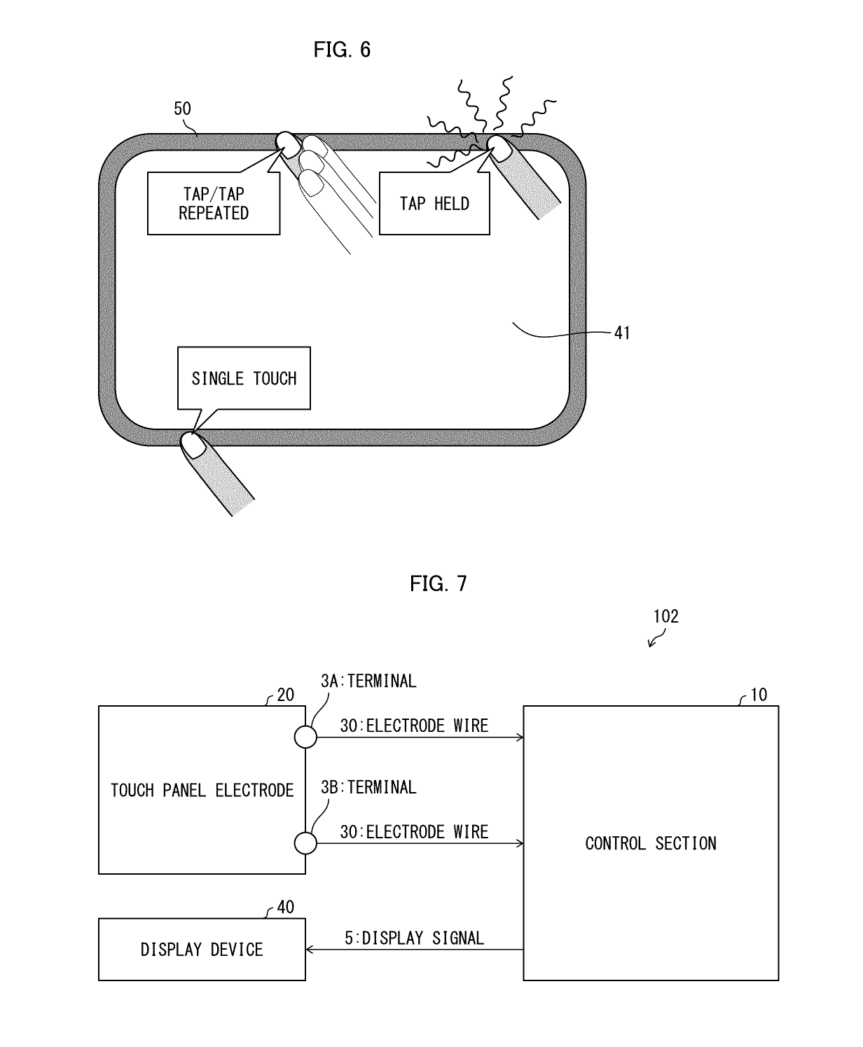

FIG. 6 is a view showing an example of a touch operation carried out with respect to the electronic device 101.

In a case where, in order to carry out the touch operation, a user makes a finger closer to the frame region 50 of the touch panel electrode 20 or touches, with the finger, the frame region 50 of the touch panel electrode 20, a weak electric current flows between the finger of the user and the touch panel electrode 20. The flow of a weak electric current between the finger of the user and the touch panel electrode causes a change in capacitance of the touch panel electrode 20. The control section 10 senses the change in capacitance of the touch panel electrode 20 and senses, in accordance with the sensed change, the touch operation carried out by the user with respect to the frame region 50. The control section 10 is configured to be capable of sensing the touch operation which is carried out by the user with respect to anywhere in the frame region 50 which surrounds the display region 41.

The control section 10 can be configured to be capable of sensing, in accordance with the change in capacitance of the touch panel electrode 20, a single touch operation in which the user touches the frame region 50 with one finger. The control section 10 can alternatively be configured to be capable of sensing (i) a tap operation in which the user taps the frame region 50 with one finger and (ii) a repeated tap operation in which the tap operation is repeatedly carried out. The control section 10 can alternatively be configured to be capable of sensing a touch and hold operation in which a state in which the user touches the frame region 50 with one finger is maintained for a time equal to or longer than a given time.

The control section 10 can alternatively be configured to specify details of the touch operation (the single touch operation, the tap operation, the repeated tap operation, or the like) in accordance with a sensing signal 3 which is generated by the control section 10 which has sensed an object coming closer to the touch panel electrode 20.

### Embodiment 2

The following description discusses an Embodiment 2 of the present invention. Note that, for convenience, members having functions identical to those of the respective members described in Embodiment 1 are given respective identical reference signs, and a description of those members is omitted here.

[Configuration of Electronic Device 102]

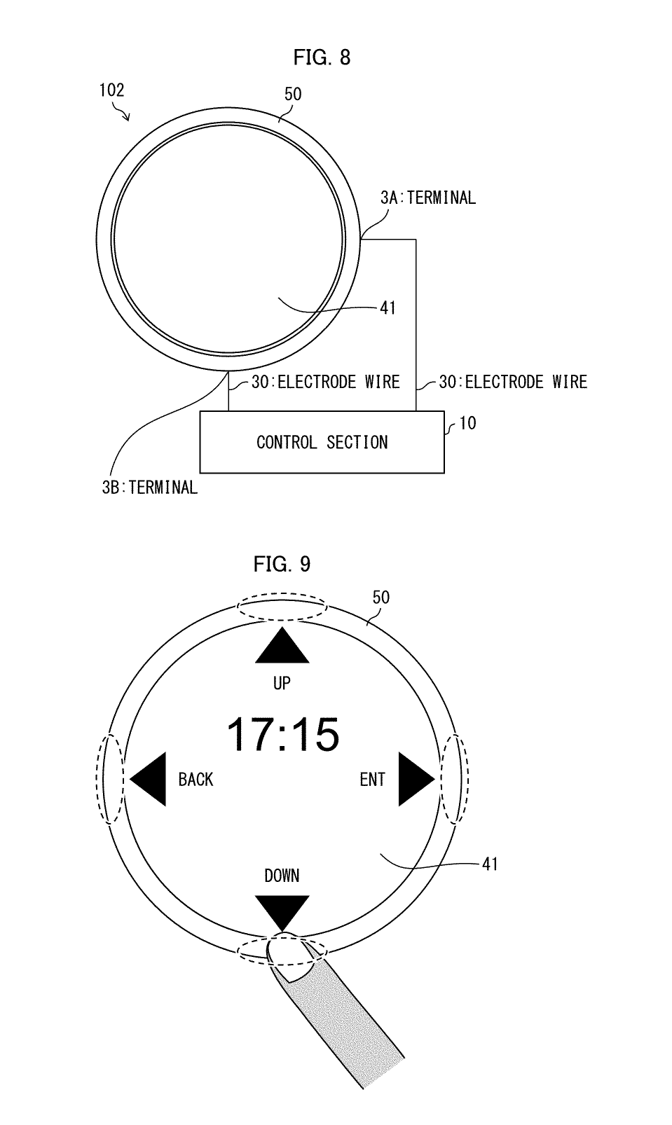

FIG. 7 is a block diagram schematically illustrating a configuration of an electronic device 102 of Embodiment 2. FIG. 8 is a view schematically illustrating the configuration of the electronic device 102. As illustrated in FIGS. 7 and 8, a plurality of electrode wires 30 which connects a touch panel electrode 20 of the electronic device 102 and a control section 10 is led from respective two or more connection points (hereinafter referred to as terminals 3A and 3B) of the touch panel electrode 20. The terminals 3A and 3B are provided in the touch panel electrode 20 so as to be located at respective two or more different positions in a circumferential direction of a display region 41. Note that the electronic device 101 of Embodiment 1 and the electronic device 102 of Embodiment 2 are identical in configuration except the number of the terminals 3A and 3B from which the respective plurality of electrode wires which connects the touch panel electrode 20 and the control section 10 is led. Thus, the description of configurations of the electronic device 102 which configurations are identical to those of the electronic device 101 is omitted here.

In a case where, in order to carry out a touch operation, a user makes a finger closer to a frame region 50 of the touch panel electrode 20 or touches, with the finger, the frame region 50 of the touch panel electrode 20, a weak electric current flows between the finger of the user and the touch panel electrode 20. The control section 10 senses a change in capacitance of the touch panel electrode 20 and senses, in accordance with the sensed change, the touch operation carried out by the user.

By, for example, a surface capacitive method, the control section 10 specifies, in accordance with capacitances of the touch panel electrode 20 which capacitances are inputted via the respective terminals 3A and 3B, details of the touch operation carried out by the user. Furthermore, by measuring a ratio between the capacitances of the touch panel electrode which capacitances are inputted via the respective terminals 3A and 3B, the control section 10 calculates a touch position at which the touch operation is carried out. By, for example, determining the touch position by measuring a ratio between (a) an amount of an electric current flowing into the terminal 3A and (b) an amount of an electric current flowing into the terminal 3B, the control section 10 can calculate the touch position at which the touch operation is carried out by the user.

The control section 10 controls sections of the electronic device 102 in accordance with the specified details of the touch operation and the calculated touch position. Note that, in a case where details of the touch operation which details have been specified in accordance with a signal indicative of a capacitance of the touch panel electrode 20 which capacitance has been obtained via one of the plurality of electrode wires 30 differ from details of the touch operation which details have been specified in accordance with a signal indicative of a capacitance of the touch panel electrode 20 which capacitance has been obtained via another one of the plurality of electrode wires 30, the control section 10 can be configured to generate a display signal 5 for displaying an error message in the display device 40.

(Example of Touch Operation)

FIG. 9 is a view showing an example of use of the touch operation carried out with respect to the electronic device 102. As illustrated in FIG. 9, the electronic device 102 can be configured such that (i) a plurality of arrows each indicating a position in a frame region 50 at which position to carry out the touch operation and (ii) operation details corresponding to the touch operation carried out with respect to an operation position indicated by a corresponding arrow are displayed in the display region 41 of the display device 40. The user can carry out a desired function of the electronic device 102 by carrying out the touch operation at a position in the frame region 50 which position is indicated by an arrow that is associated with desired operation details.

According to the electronic device 102 which is configured as described above, the touch panel electrode 20 is provided in the frame region 50 which is provided so as to surround the display region 41. This prevents a wiring pattern of a touch panel from being visible in the display region 41, and consequently prevents impairment of a display quality of the display device 40. Furthermore, since the touch panel electrode 20 includes the terminals 3A and 3B which are provided so as to be located at respective two or more different positions, by measuring a ratio between the capacitances of the touch panel electrode 20 which capacitances are inputted via the respective terminals 3A and 3B, the control section 10 can calculate a touch position at which the touch operation is carried out.

According to the electronic device 102 which is configured as described above, a simple configuration makes it possible to sense various touch operations each corresponding to (i) details of the touch operation and (ii) a position at which the touch operation is carried out. This allows fewer or no mechanical operators to be provided on, for example, an outer circumference of the electronic device 102, and consequently allows the electronic device 102 to be designed with a higher degree of freedom.

### Embodiment 3

The following description discusses Embodiment 3 of the present invention. Note that, for convenience, members having functions identical to those of the respective members described in Embodiment 1 or 2 are given respective identical reference signs, and a description of those members is omitted here.

[Configuration of Electronic Device 103]

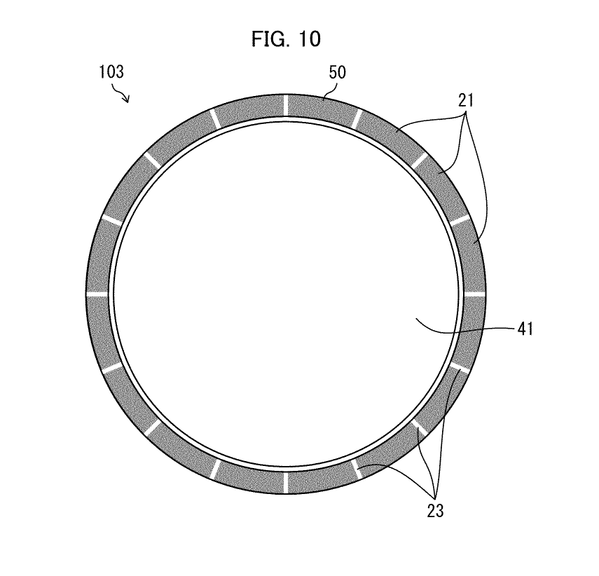

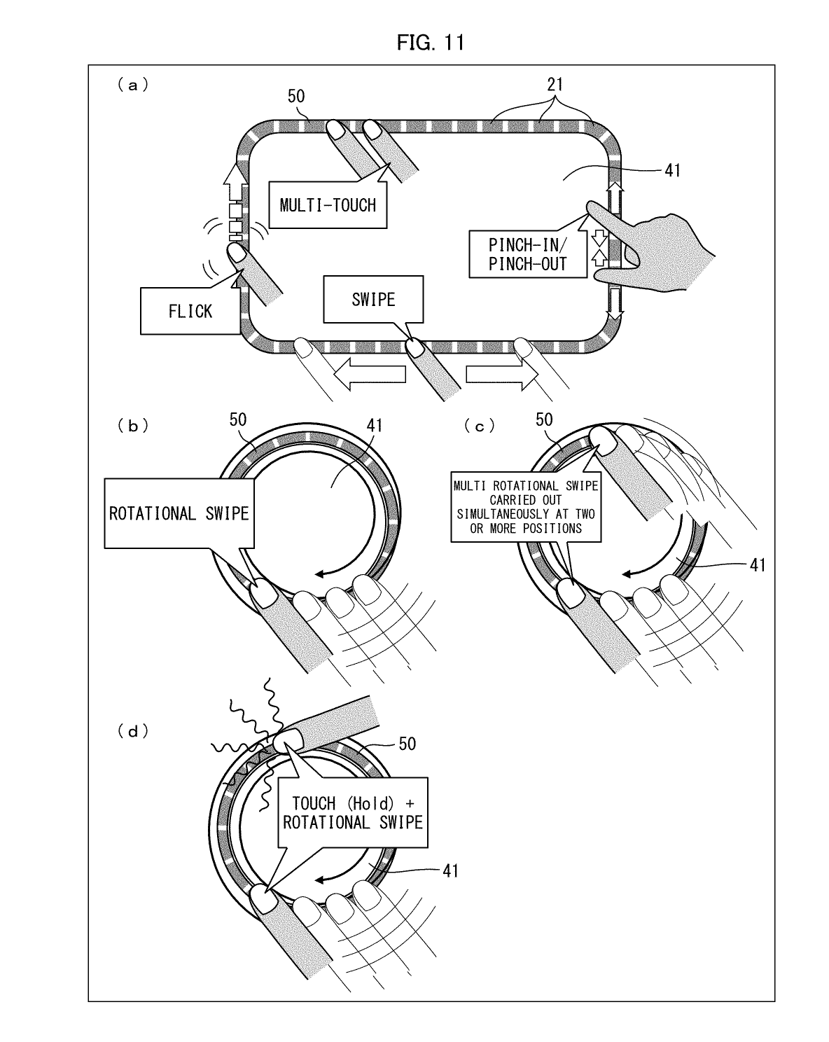

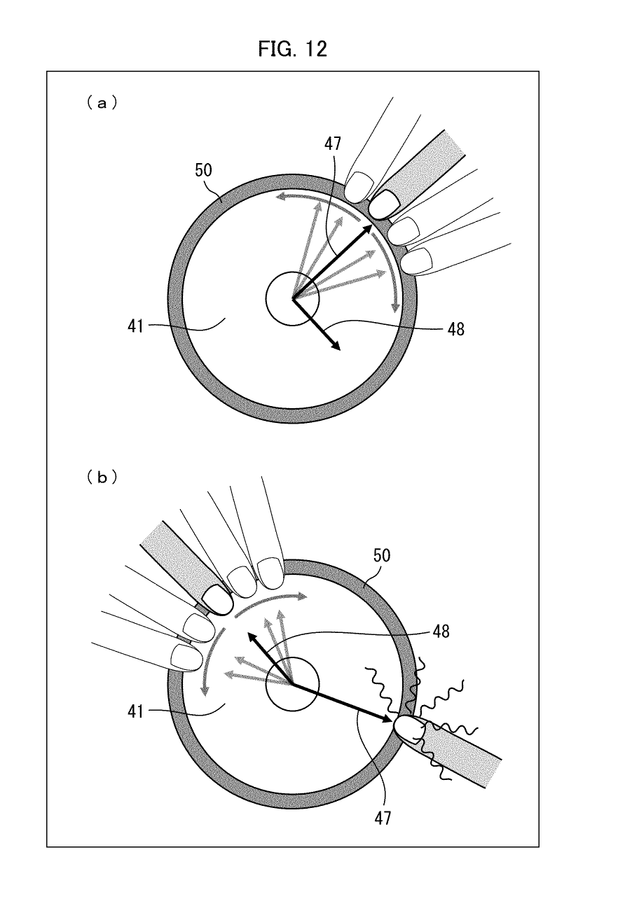

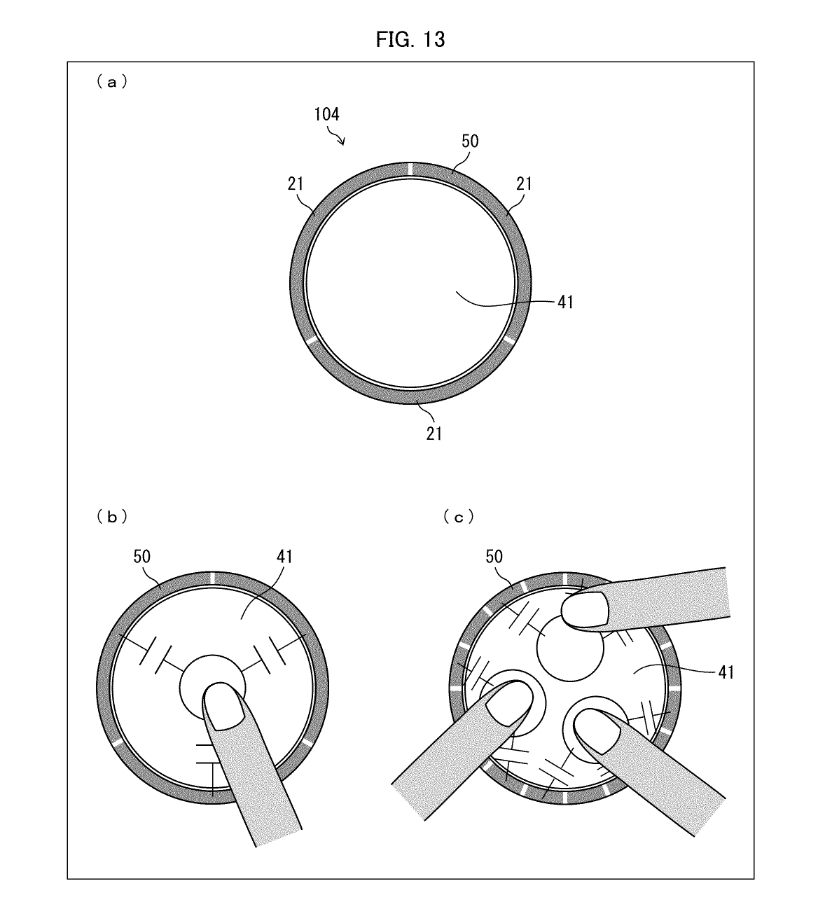

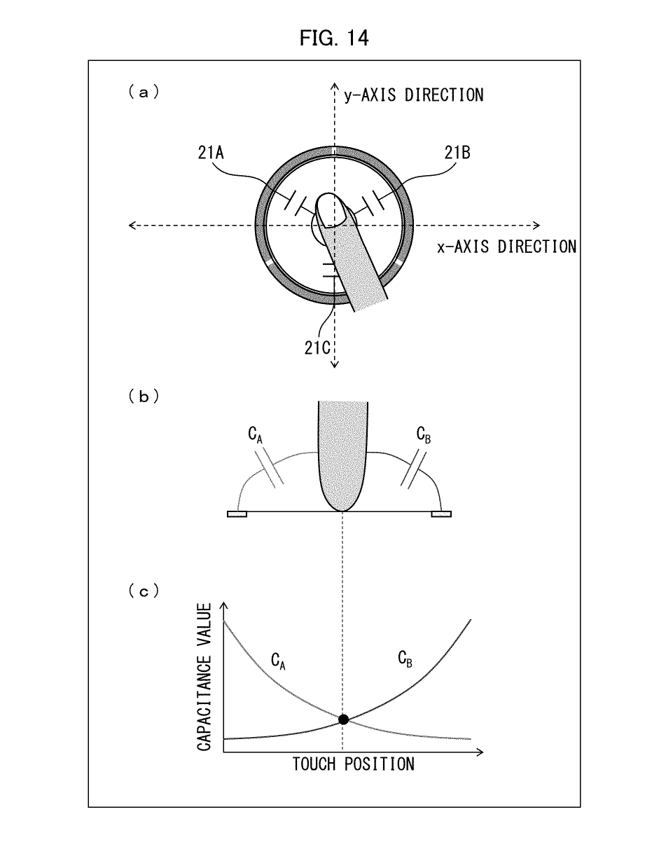

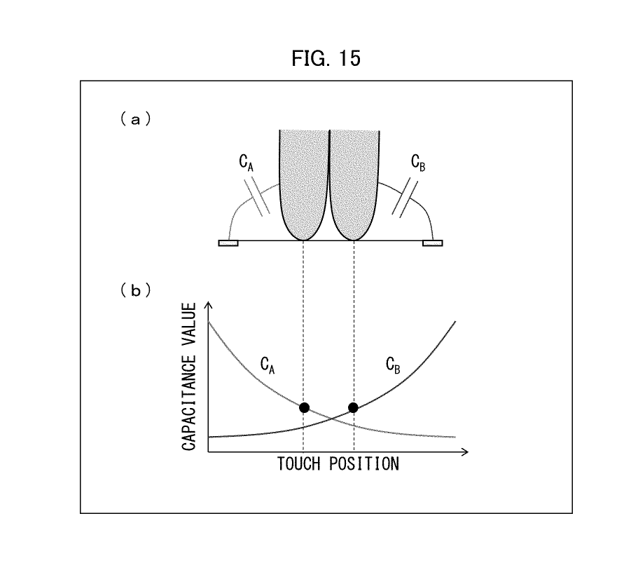

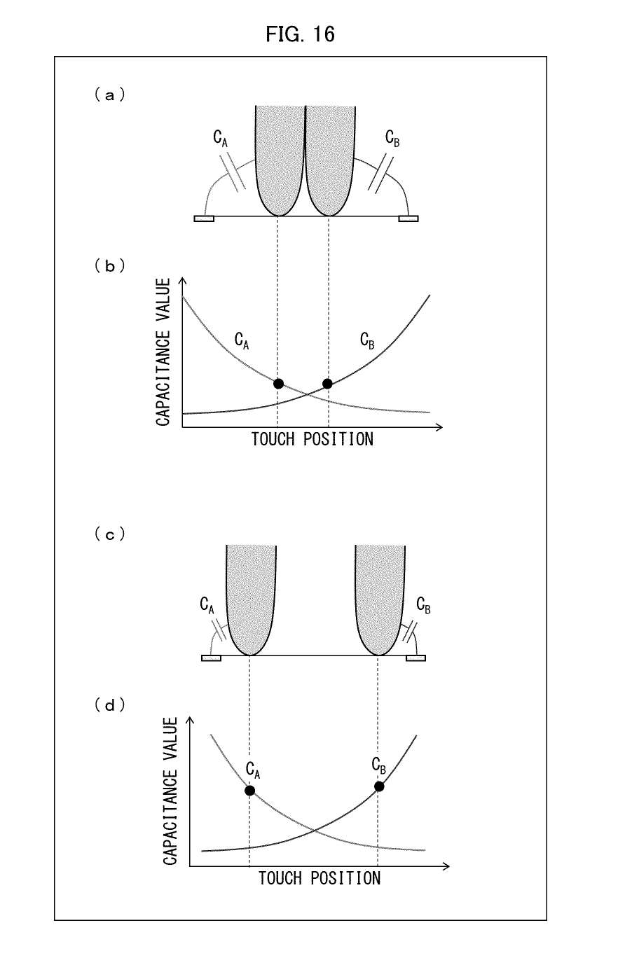

FIG. 10 is a view schematically illustrating a configuration of an electronic device 103 of Embodiment 3. As illustrated in FIG. 10, the electronic device 103 includes a touch panel electrode 20 which has a plurality of partial electrodes 21. The plurality of partial electrodes 21 is provided side by side in a frame region 50 which surrounds a display region 41. A gap 23 is provided between respective adjacent partial electrodes 21. The touch panel electrode 20 is configured such that a space between the respective adjacent partial electrodes 21 is insulated by the gap 23 so that no electric current flows between the partial electrodes 21.

FIG. 10 illustrates the electronic device 103 which includes the touch panel electrode 20 which has 16 partial electrodes 21. Note, however, that the touch panel electrode 20 does not necessarily need to have 16 partial electrodes 21. The touch panel electrode 20 only needs to have at least three partial electrodes 21. Note also that the touch panel electrode 20 which has more partial electrodes 21 allows a touch operation to be sensed with higher accuracy.

Each of the plurality of partial electrodes 21 is connected to a control section 10, though not illustrated.

(Example of Touch Operation)

(a) through (d) of FIG. 11 are views each showing an example of a touch operation carried out with respect to the electronic device 103.

In a case where, in order to carry out a touch operation with respect to the frame region 50 in which the touch panel electrode 20 which is made up of the plurality of partial electrodes 21 is provided, a user makes a finger closer to the frame region 50 or touches the frame region 50 with the finger, a weak electric current flows between the finger of the user and at least one of the partial electrodes 21. The control section 10 senses a partial electrode 21 whose capacitance has changed.

The control section 10 detects, in accordance with the capacitance of the partial electrode 21, details of the touch operation carried out by the user. Furthermore, as illustrated in, for example, (a) of FIG. 11, the control section 10 which senses that a change in capacitance occurs in the plurality of partial electrodes 21 detects that the touch operation carried out by the user is a multi-touch operation, which is a touch operation carried out with use of a plurality of fingers. Moreover, the control section 10 can be configured to be capable of detecting, in accordance with a position of a partial electrode 21 whose change in capacitance has been sensed, touch operations (e.g., a flick operation and a swipe operation) to gradually slidably move a finger of the user with use of which finger the user is carrying out the touch operation.

The control section 10 which senses that a change in capacitance occurs in two or more partial electrodes 21 can detect, in accordance with respective positions of these partial electrodes 21, a pinch-out operation to gradually move fingers, with use of which the user is carrying out the touch operation, in a direction in which the fingers are away from each other. Meanwhile, the control section 10 which senses that a change in capacitance occurs in two partial electrodes 21 can detect, in accordance with respective positions of these partial electrodes 21, a pinch-in operation to gradually move fingers, with use of which the user is carrying out the touch operation, in a direction in which the fingers come closer to each other.

The touch panel electrode 20 thus configured to have the plurality of partial electrodes 21 can respond to, for example, the multi-touch operation, which is a touch operation carried out with use of a plurality of fingers, and any of the flick operation, the swipe operation, the pinch-in operation, and the pinch-out operation, each of which is carried out by slidably moving a finger(s). Thus, a plurality of types of functions can be carried out by the touch operation carried out with respect to the frame region 50 which surrounds the display region 41. This makes it possible to achieve, without impairing a display quality of the display region 41, a wider variety of user interfaces each of which is operated by a touch operation.

Furthermore, as illustrated in (b) of FIG. 11, the control section 10 can be configured to be capable of detecting a rotational swipe operation to move a finger along a surface of the frame region 50 as with, for example, dialing. For example, the control section 10 can be configured to be capable of carrying out, by the rotational swipe operation, an operation to adjust volume of an output voice and an operation to adjust a size of an image that is being displayed in a display. This allows the electronic device 103 to be more operable by the touch operation.

Moreover, as illustrated in (c) of FIG. 11, the control section 10 can be configured to be capable of detecting a multi rotational swipe operation to simultaneously move different fingers along the surface of the frame region 50 at respective two or more positions on that surface. The control section 10 thus can carry out an operation in which the rotational swipe operation and the multi-touch operation are combined. This allows the electronic device 103 to be more operable by the touch operation.

Further, as illustrated in (d) of FIG. 11, the control section 10 can be configured to be capable of detecting an operation in which (i) a hold operation to maintain a state in which at least one place in the frame region 50 is touched with a finger and (ii) the rotational swipe operation to move, along the surface of the frame region 50, a finger with which another place, different from the at least one place, in the frame region 50 is touched are carried out.

(a) and (b) of FIG. 12 are views each showing an example of use of a function of the electronic device 103 which function can be carried out by the rotational swipe operation to move a finger along the surface of the frame region 50. As illustrated in (a) of FIG. 12, the electronic device 103 can be configured to be capable of carrying out a time regulating function by rotating a clock long hand 47 by carrying out the rotational swipe operation to move a finger along the surface of the frame region 50 as with, for example, dialing. As illustrated in (b) of FIG. 12, the electronic device 103 can alternatively be configured to be capable of carrying out the time regulating function by (i) carrying out the hold operation to hold the clock long hand 47 by touching the surface of the frame region 50 with a finger at a position on the extension of the clock long hand 47, and (ii) rotating a clock short hand 48 by carrying out the rotational swipe operation to move, along the surface of the frame region 50, a finger with which the surface of the frame region 50 is touched at a position on the extension of the clock short hand 48.

### Embodiment 4

The following description discusses Embodiment 4 of the present invention. Note that, for convenience, members having functions identical to those of the respective members described in Embodiments 1 through 3 are given respective identical reference signs, and a description of those members is omitted here.

[Configuration of Electronic Device 104]

(a) through (c) of FIG. 13 are views each schematically illustrating a configuration of an electronic device 104 of Embodiment 4. The above description of Embodiments 1 through 3 discusses the configuration in which the touch operation carried out with respect to the frame region 50 is detected. The following description of Embodiment 4 discusses the electronic device 104 which is capable of detecting a touch operation carried out with respect to each of a frame region 50 and a display region 41.

As illustrated in FIG. 13, the electronic device 104 includes a touch panel electrode 20 which has a plurality of partial electrodes 21. As illustrated in (a) of FIG. 13, the touch panel electrode 20 only needs to have at least three partial electrodes 21. Note that the electronic device 104 which has more partial electrodes 21 allows the touch operation to be sensed with higher accuracy.

As illustrated in (b) of FIG. 13, in a case where the touch panel electrode 20 is configured to have three partial electrodes 21, a control section 10 of the electronic device 104 can detect the touch operation carried out with respect to a point in either one of the frame region 50 and the display region 41.

Furthermore, as illustrated in (c) of FIG. 13, in a case where the touch panel electrode 20 is configured to have more partial electrodes 21, the control section 10 of the electronic device 104 can detect a multi-touch operation carried out with respect to a plurality of points in the frame region 50 and the display region 41.

According to the electronic device 104, the display region 41 has a size small enough to be within an electric field of the touch panel electrode 20 which is provided in the frame region 50 which surrounds the display region 41. In a case where the display region 41 of the display device 40 thus has a size small enough to be within the electric field of the touch panel electrode 20, it is possible to detect the touch operation carried out with respect to not only the frame region 50 but also the display region 41.

[Principle of Detection of Touch Position]

(a) through (c) of FIG. 14 are views each show an example of a principle on which to detect, in the electronic device 104 which includes the touch panel electrode 20 which has three partial electrodes 21, a touch position at which the touch operation is carried out in the display region 41. As illustrated in (a) of FIG. 14, the touch panel electrode 20 is made up of three partial electrodes 21A, 21B, and 21C which are provided in the frame region 50 which surrounds the display region 41.

In a case where the user carries out the touch operation with respect to a point in the display region 41, the control section 10 senses a change in capacitance which change occurs due to a flow of a weak electric current between (a) the respective partial electrodes 21A, 21B, and 21C and (b) a finger of the user. The control section 10 can be configured such that data that shows a relative relationship between (a) a capacitance value shown in (c) of FIG. 14 and (b) a touch position at which the touch operation is carried out with use of a finger is stored in advance. The control section 10 can be configured such that the touch position at which the touch operation is carried out is calculated with reference to (i) respective capacitance values of the partial electrodes 21A, 21B, and 21C and (ii) the data which is stored in advance.

As illustrated in (a) of FIG. 14, in a case where the user carries out the touch operation with respect to a point in the display region 41, a weak electric current flows between (a) the respective partial electrodes 21A, 21B, and 21C and (b) the finger of the user. The control section 10 calculates the touch position in accordance with the respective capacitance values of the partial electrodes 21A, 21B, and 21C. For example, the control section 10 calculates the touch position in an x-axis direction of (a) of FIG. 14 in accordance with respective capacitance values C_{A} and C_{B} of the partial electrodes 21A and 21B as illustrated in (b) of FIG. 14. The control section 10 similarly calculates the touch position in a y-axis direction of (a) of FIG. 14 in accordance with (i) respective capacitance values of the partial electrodes 21A and 21C and (ii) respective capacitance values of the partial electrodes 21B and 21C. The control section 10 calculates, in accordance with the touch positions in the respective x-axis and y-axis directions which touch positions are calculated in accordance with the respective capacitance values of the partial electrodes 21A, 21B, and 21C, the touch position at which the touch operation is carried out with use of the finger of the user.

(a) and (b) of FIG. 15 are views each showing an example of a principle on which to detect a difference in capacitance in a case where a double touch operation is carried out in the display region 41 unlike a case where a single touch operation is carried out with respect to the display region 41. As illustrated in (a) of FIG. 15, in a case where the user carries out the double touch operation in the display region 41, a weak electric current flows between (a) the respective partial electrodes 21A, 21B, and 21C and (b) a finger of the user.

As illustrated in (b) of FIG. 15, the respective capacitance values of the partial electrodes 21A and 21B which capacitance values are obtained in a case where the double touch operation is carried out differ from the respective capacitance values of the partial electrodes 21A and 21B which capacitance values are shown in (c) of FIG. 14 and obtained in a case where the single touch operation is carried out. In accordance with a difference in the respective capacitance values of the partial electrodes 21A, 21B, and 21C from the case where the single touch operation is carried out, the control section 10 can detect the user carrying out the double touch operation in the display region 41. The control section 10 thus can detect, in accordance with the respective capacitance values of the partial electrodes 21A, 21B, and 21C, whether the touch operation carried out by the user in the display region 41 is the single touch operation or the double touch operation.

Furthermore, the control section 10 can calculate, in accordance with a difference in the respective capacitance values of the partial electrodes 21A, 21B, and 21C which difference is caused by a difference in position between two fingers with use of which to carry out the double touch operation, touch positions at which the double touch operation is carried out with use of the respective two fingers. (a) through (d) of FIG. 16 are views each show an example of a principle on which to detect respective positions of two fingers with use of which the double touch operation is being carried out in the display region 41.

(b) and (d) of FIG. 16 illustrate a change in the respective capacitance values C_{A} and C_{B} of the partial electrodes 21A and 21B which change occurs in a case where a pinch out (zoom out or enlargement) operation to move the two fingers, which are illustrated in (a) of FIG. 16 and with which the display region 41 is touched, in a direction in which the two fingers are away from each other (see (c) of FIG. 16). As illustrated in (b) and (d) of FIG. 16, the respective capacitance values C_{A} and C_{B} of the partial electrodes 21A and 21B vary in accordance with the respective positions of the two fingers. This allows the control section 10 to calculate, in accordance with the change in the capacitance values C_{A} and C_{B}, the touch positions at which the double touch operation is carried out with use of the respective two fingers. Furthermore, the control section 10 can calculate, in accordance with the change in the respective capacitance values of the partial electrodes 21A, 21B, and 21C, (i) the touch positions in the x-axis direction of (a) of FIG. 14 at which touch positions the double touch operation is carried out with use of the respective two fingers and (ii) the touch positions in the y-axis direction of (a) of FIG. 14 at which touch positions the double touch operation is carried out with use of the respective two fingers. This allows the control section 10 to calculate the touch positions in the display region 41 at which touch positions the double touch operation is carried out with use of the respective two fingers.

[Recap]

An electronic device 101 in accordance with a first aspect of the present invention includes: a display device 40 including a display region 41 and a frame region 50; a touch panel electrode 20 provided so as to surround the display region 41; and a control section 10 connected to the touch panel electrode 20 and configured to sense, in accordance with a change in capacitance of the touch panel electrode 20, a touch operation carried out by an object coming into contact with or coming closer to at least one of the display region 41 and the frame region 50.

The configuration makes it possible to achieve an electronic device with a high display quality while preventing a wiring pattern of a touch panel from being visually recognized in the display region 41. Furthermore, the wiring pattern of the touch panel, which wiring pattern is invisible in the display region 41, causes no reduction in transmittance of the display region 41. This allows the display region 41 to be brighter, or allows a reduction in electric power of the back bezel 44.

An electronic device 102 in accordance with a second aspect of the present invention can be configured, in the first aspect, to further include: a plurality of electrode wires 30 which connects the touch panel electrode 20 and the control section 10, the plurality of electrode wires 30 being led from respective two or more different positions in the touch panel electrode 20.

The configuration makes it possible to sense the touch operation in accordance with respective capacitances of the plurality of electrode wires 30.

An electronic device 102 in accordance with a third aspect of the present invention can be configured such that, in the second aspect, the control section 10 calculates, in accordance with a change in capacitances which are inputted via the respective plurality of electrode wires 30 which is led from the respective two or more different positions in the touch panel electrode 20, a touch position at which the touch operation is carried out.

The configuration makes it possible to calculate, in accordance with a ratio between electric currents flowing through the respective plurality of electrode wires 30, the touch position at which the touch operation is carried out.

An electronic device 103 in accordance with a fourth aspect of the present invention can be configured such that: in the second or third aspect, the touch panel electrode 20 has a plurality of partial electrodes 21; and the plurality of partial electrodes 21 is provided side by side in the frame region 50.

The configuration makes it possible to sense the touch operation in accordance with a change in respective capacitances of the plurality of partial electrodes 21. This allows various touch operations to be detected in accordance with, for example, the number of fingers with use of which to carry out the touch operation, the touch position at which the touch operation is carried out, and/or details of the touch operation.

An electronic device 104 in accordance with a fifth aspect of the present invention can be configured such that: in the fourth aspect, the plurality of partial electrodes 21 is connected to the control section 10 by the respective plurality of electrode wires 30; and the control section 10 calculates, in accordance with a change in respective capacitances of the plurality of partial electrodes, at least one touch position at which the touch operation is carried out.

According to the configuration, without the need to form a wiring pattern of a touch panel in the display region 41, it is possible to detect, with high accuracy, the touch position at which the touch operation is carried out with respect to at least one of the display region 41 and the frame region 50 which surrounds the display region 41.

An electronic device 104 in accordance with a sixth aspect of the present invention can be configured such that: in the fourth aspect, the plurality of partial electrodes 21 is connected to the control section 10 by the respective plurality of electrode wires 30; and the control section 10 calculates, in accordance with a change in respective capacitances of the plurality of partial electrodes 21, the number of at least one touch position at which the touch operation is carried out.

According to the configuration, without the need to form a wiring pattern of a touch panel in the display region 41, it is possible to detect, with high accuracy, the number of fingers with use of which to carry out the touch operation with respect to at least one of the display region 41 and the frame region 50 which surrounds the display region 41.

An electronic device 104 in accordance with a seventh aspect of the present invention can be configured such that, in the fifth or sixth aspect, the control section 10 calculates, in accordance with the change in the respective capacitances of the plurality of partial electrodes 21, a plurality of touch positions which the at least one touch position at which the touch operation is carried out comprises.

According to the configuration, without the need to form a wiring pattern of a touch panel in the display region 41, it is possible to detect, with high accuracy, (i) the number of fingers with use of which the touch operation is being carried out with respect to at least one of the display region 41 and the frame region 50 which surrounds the display region 41 and (ii) the touch positions at which the touch operation is carried out with use of the respective fingers.

An electronic device 101,102, or 103 in accordance with an eighth aspect of the present invention can be configured such that, in any one of the first through seventh aspects, the display device 40 is a flat panel display including a CF substrate 42 and a TFT substrate 43; and the touch panel electrode 20 is provided so as to be located between the CF substrate 42 and a cover glass 45 which covers a surface of the CF substrate 42.

The configuration makes it possible to form the touch panel electrode 20 in the frame region 50 in a form of an out-cell touch panel.

An electronic device in accordance with a ninth aspect of the present invention can be configured such that, in any one of the first through seventh aspects, the display device is a flat panel display including a CF substrate and a TFT substrate; and the touch panel electrode is provided so as to be located between the CF substrate and the TFT substrate.

The configuration makes it possible to form the touch panel electrode 20, in a form of an in-cell touch panel, in the frame region 50 which surrounds the display region 41.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

10 Control section

20 Touch panel electrode

21 Partial electrode

40 Display device

41 Display region

50 Frame region

101, 102, 103, 104 Electronic device

1. An electronic device comprising:
a display device including a display region and a frame region;
a touch panel electrode provided so as to surround the display region; and
a control section connected to the touch panel electrode and configured to sense, in accordance with a change in capacitance of the touch panel electrode, a touch operation carried out by an object coming into contact with or coming closer to at least one of the display region and the frame region.

2. The electronic device as set forth in claim 1, further comprising:
a plurality of electrode wires which connects the touch panel electrode and the control section, the plurality of electrode wires being led from respective two or more different positions in the touch panel electrode.

3. The electronic device as set forth in claim 2, wherein the control section calculates, in accordance with a change in capacitances which are inputted via the respective plurality of electrode wires which is led from the respective two or more different positions in the touch panel electrode, a touch position at which the touch operation is carried out.

4. The electronic device as set forth in claim 2, wherein:
the touch panel electrode has a plurality of partial electrodes; and
the plurality of partial electrodes is provided side by side in the frame region.

5. The electronic device as set forth in claim 4, wherein:
the plurality of partial electrodes is connected to the control section by the respective plurality of electrode wires; and
the control section calculates, in accordance with a change in respective capacitances of the plurality of partial electrodes, at least one touch position at which the touch operation is carried out.

6. The electronic device as set forth in claim 4, wherein:
the plurality of partial electrodes is connected to the control section by the respective plurality of electrode wires;
and the control section calculates, in accordance with a change in respective capacitances of the plurality of partial electrodes, the number of at least one touch position at which the touch operation is carried out.

7. The electronic device as set forth in claim 5, wherein the control section calculates, in accordance with the change in the respective capacitances of the plurality of partial electrodes, a plurality of touch positions which the at least one touch position at which the touch operation is carried out comprises.

8. The electronic device as set forth in claim 1, wherein:
the display device is a flat panel display including a CF substrate and a TFT substrate; and
the touch panel electrode is provided so as to be located between the CF substrate and a cover glass which covers a surface of the CF substrate.

9. The electronic device as set forth in claim 1, wherein:
the display device is a flat panel display including a CF substrate and a TFT substrate; and
the touch panel electrode is provided so as to be located between the CF substrate and the TFT substrate.
